(19) United States
(12) Patent Application Publication
(10) Pub. No.: US 2016/0034826 A1
(43) Pub. Date: Feb. 4, 2016

(54) GLOBAL SEAT ALLOCATOR

(71) Applicant: Bank of America Corporation, Charlotte, NC (US)

(72) Inventors: Sukhvinder Gurnam Singh, Mumbai (IN); Herbert Kailash Fernandes, Mumbai (IN); Sarvesh Neelakanta Subramani, Mumbai (IN)

(21) Appl. No.: 14/445,717

(22) Filed: Jul. 29, 2014

(51) Int. Cl. G06Q 10/02

(52) U.S. Cl. CPC G06Q 10/02

(57) ABSTRACT

Systems, apparatus, and computer program products provide real-time access to seating/work station information, including seat allocations/assignments and seat availability. Users are provided the ability to request a seat for allocation and to receive confirmation of the seat allocation/assignment in real-time. The automated nature of the present invention eliminates seat request/allocation duplication caused by multiple managers individually requesting seats manually and, in doing so, eliminates the resulting rework associated with duplicate requests/allocations. Moreover, the real-time functionality of the present invention reduces or eliminates the need to consolidate allocation requests and updates. In addition, the real-time view of seat allocations provides for instantaneous and up-to-the-minute analysis, data and reporting, which results in more timely decisions regarding seat allocations.

### FIELD

In general, embodiments of the invention relate to business management and, more particularly, allocating seat assignments in an enterprise-wide business environment, such as a world-wide call center environment and providing real-time insight into which seats within a specified floor plan have been assigned and which seats are available for assignment.

### BACKGROUND

Seat allocation and utilization is especially important in those business environments in which associates/employees occupy work stations over various time shifts, around-the-clock 24/7 (i.e., twenty-four hours a day and seven days a week). For example, in those business environments which implement call centers, call center associates/employees may be constantly required to take calls from customers (i.e., occupy a seat or work station within the call center). In such business environments, no single employee/associate is permanently assigned to a seat/work station, since work schedules will vary amongst the employees/associates and multiple work shifts (e.g., morning shift, mid-day shift, night shift and the like) necessitate that seats/work stations be occupied more than once within a work shift cycle.

Currently allocation of seat assignments within a business environment requiring such is conducted by business managers manually on a regularly scheduled basis, such as weekly, monthly or the like. Such manual allocation of seats, in which each manager or the like separately requests seat allocations is a cumbersome task since managers making seat allocation selections are not aware of what the other managers are requesting. As such, manual consolidation of the seat allocations requests is necessary, which is a time-consuming endeavor that results in an inordinate amount of rework. Moreover, the manual process is prone to human errors, such as managers failing to provide seat allocation requests and/or updates, likely occurrences of seat allocation duplications, issues identifying, reporting and addressing dual/redundant seat allocation requests and the like. This problem becomes even more exasperated when the collation of seat allocation data and the reporting of seat allocation data is conducted across different job functions and different physical geographies. In addition, such manual processing does not allow the managers and the like any real-time access to data and/or reports that would indicate seat allocation and/or seat availability.

Therefore, a need exists to develop systems, apparatus, methods, computer program products and the like that provide for real-time allocation of seats/work stations in a business environment requiring such. As such, the desired embodiments should provide for real-time insight into which seats are currently allocated and which seats are available for assignment. Moreover, the desired embodiments should alleviate problems associated with the manual processing of seat allocation, such as duplicate allocation/assignments and required rework. In addition, the desired embodiments should provide for seat allocation to occur at any time and, as such, not be relegated to a regularly scheduled (i.e., monthly or the like) process and for seat allocation insight, in the form of reports or the like, to be extracted/generated in real-time on an as-needed basis.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, computer program products or the like for providing real-time access to seating information, including seat allocations/assignments and availability. Additionally, embodiments of the invention provide for users, such as managers or the like, to request a seat for allocation and to receive confirmation of the seat allocation/assignment in real-time. The automated nature of the present invention eliminates seat request/allocation duplication caused by multiple managers individually requesting seats manually and, in doing so, eliminates the resulting rework associated with duplicate requests/allocations. Moreover, the real-time functionality of the present invention reduces or eliminates the need to consolidate allocation requests and updates. In addition, the real-time view of seat allocations provides for instantaneous and up-to-the-minute analysis, data and reporting, which results in more timely decisions regarding seat allocations. Additionally, by providing for real-time updates in the form of seat releases of surplus seats or the like, better utilization of seats/work stations results across the business.

An apparatus for providing seat allocation within a seating floor plan of a business environment defines first embodiments of the invention. The apparatus includes a computing platform having a memory and at least one processor in communication with the memory.

The apparatus further includes a seat allocation module that is stored in the memory and executable by the processor. The module is configured to receive a first user-input that selects a seating floor plan of a business location and, in response to receiving the first user-input, determine a current seat allocation for a plurality of seats included in the seating floor plan. The module is further configured to provide a display of a map of the seating floor plan that indicates the current seat allocation for the plurality of seats included in the seating floor plan. In addition, the module is further configured to receive a second user-input that selects one or more the seats displayed in the map of the seating floor plan and requests a change in seat allocation for the one or more selected seats and, in response to receiving the second user-input, updating, in real-time, the display of the map of the seat floor plan to indicate the change in the seat allocation for the one or more selected seats.

In specific embodiments of the apparatus, the seat allocation module is further configured to, in response to receiving the second user-input, store, in a centralized database, the change in the seat allocation in a corresponding seat assignment record.

In further specific embodiments of the apparatus, the seat allocation module is further configured to provide the display of the map of the seating floor plan that indicates for each seat displayed in the map one of (1) allocated for a next-in-time work shift cycle, or (2) a next-in-time work shift that the seat is available for allocation. In such embodiments of the apparatus, the seat allocation module is further configured to determine the next-in-time work shift that the seat is available for allocation based on length of time of a work shift period and a shift start time associated with a seat assignment.

In still further specific embodiments of the apparatus, the seat allocation module is further configured to provide the display of the map of the seating floor plan that indicates the current seat allocation for a plurality of work stations included in the seating floor plan, wherein each work stations includes one or more seats.

In additional specific embodiments of the apparatus, the seat allocation module is further configured to receive the second user-input that selects one of the seats in the map of the seating floor plan and requests seat assignment for the selected seat, wherein seat assignment includes an associate name that is being assigned to the seat and shift start time. While in other specific embodiments of the apparatus, the seat allocation module is further configured to receive the second user-input that selects a plurality of the seats and requests release of seat assignment for the selected plurality of seats.

Moreover, in other embodiments of the apparatus, the seat allocation module is further configured receive the first user-input that selects the seating floor plan of a business location, wherein the seating floor plan is specific to a least one of a physical location, a building at the physical location and a floor within the building.

Further specific embodiments of the apparatus provide for the seat allocation module is further configured to receive a third user-input that selects a seat report for the seating floor plan and, in response to receiving the third user-input, generate, in real-time, the seat report and provide a seat report display to the user that includes details of current seat allocation. While other specific embodiments of the apparatus provide for the seat allocation module is further configured to receive a third user-input that selects a seat allocation analytics and, in response to receiving the third user-input, generate, in real-time, seat allocation analytics that includes statistics related to seat allocation.

A method for assigning seats at a workplace seating location defines second embodiments of the invention. The method includes receiving first user-input that selects seating floor plan of a business location and, in response to receiving the first user-input, determining a current seat allocation for a plurality of seats included in the seating floor plan. The method further includes providing a display of a map of the seating floor plan that indicates the current seat allocation for the plurality of seats included in the seating floor plan. In addition, the method includes receiving a second user-input that selects one or more the seats displayed in the map of the seating floor plan and requests a change in seat allocation for the one or more selected seats and, in response to receiving the second user-input, updating, in real-time, the display of the map of the seat floor plan to indicate the change in the seat allocation for the one or more selected seats.

In specific embodiments the method further includes, in response to receiving the second user-input, storing, in a centralized database, the change in the seat allocation in a corresponding seat assignment record.

In further specific embodiments of the method, providing the display of the map further includes providing the display of the map of the seating floor plan that indicates for each seat displayed in the map one of (1) allocated for a next-in-time work shift cycle, or (2) a next-in-time work shift that the seat is available for allocation. In such embodiments the method further includes determining the next-in-time work shift that the seat is available for allocation based on length of time of a work shift period and a shift start time associated with a seat assignment.

In still further specific embodiments of the method, providing display of the map further includes providing the display of the map of the seating floor plan that indicates the current seat allocation for a plurality of work stations included in the seating floor plan, such that, each work stations includes one or more seats.

Moreover, in further specific embodiments of the method, receiving the second user-inputs further includes receiving the second user-input that selects one of the seats in the map of the seating floor plan and requests seat assignment for the selected seat, such that, the seat assignment includes an associate name that is being assigned to the seat and shift start time. While in other embodiments of the method, receiving the second user-inputs further includes receiving the second user-input that selects a plurality of the seats and requests release of seat assignment for the selected plurality of seats.

In additional specific embodiments the method includes receiving a third user-input that selects one of (1) a seat report for the seating floor plan or (2) seat allocation analytics and, in response to receiving the third user-input, generate, in real-time, (1) the seat report, or (2) seat allocation analytics and provides (1) a seat report display to the user that includes details of current seat allocation, or (2) seat allocation analytics that includes statistics related to seat allocation.

In still further embodiments the method includes receiving third user-input that select a work shift for indicating seat availability on the map and, in response to receiving the third user-input, providing display of a work shift-specific map that indicates which seats are available for assignment during the selected work shift.

A computer program product including a non-transitory computer-readable medium defines third embodiments of the invention. The computer program product includes a first set of codes for causing a computer to receive a first user-input that selects seating floor plan of a business location and a second set of codes for causing a computer to, in response to receiving the first user-input, determine a current seat allocation for a plurality of seats included in the seating floor plan. In addition, the computer-readable medium includes a third set of codes for causing a computer to provide a display of a map of the seating floor plan that indicates the current seat allocation for the plurality of seats included in the seating floor plan. Moreover, the computer-readable medium includes a fourth set of codes for causing a computer to receive a second user-input that selects one or more the seats displayed in the map of the seating floor plan and requests a change in seat allocation for the one or more selected seats and a fifth set of codes for causing a computer to, in response to receiving the second user-input, update, in real-time, the display of the map of the seat floor plan to indicate the change in the seat allocation for the one or more selected seats.

Thus, systems, apparatus, methods, and computer program products herein described in detail below provide for an application that assists users to view, in real-time, seating information, such as current seat allocation and provides for users to make changes to current seat allocations (i.e., request an allocation/assignment of a currently available seat or release a seat from a current allocation/assignment). Present embodiments provide for seat assignment records to be up-dated in real-time and reflected in a displayed map of the seating floor. In addition, embodiments provide for real-time seat allocation reporting that provide a comprehensive listing of seating allocation details and real-time seating allocation analytics that provide up-to-the-minute statistics and the like regarding seating allocation/assignment.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured for providing seating allocation information, including requesting seating allocation in business environment, in accordance with embodiments of the present invention;

FIG. 2 provides a more detailed block diagram of an apparatus configured for providing seating allocation information, including requesting seating allocation in business environment, in accordance with embodiments of the present invention;

FIG. 3 provides a flow diagram of a method for allocating seat assignments in a business environment, in accordance with embodiments of the present invention;

FIG. 4 provides a schematic representation of a user-interface configured for selecting a seating floor plan of a business location, in accordance with embodiments of the present invention;

FIG. 5 provides a schematic representation of a user-interface displaying a map of a selected seating floor plan, in accordance with embodiments of the present invention;

FIG. 6 provides a schematic representation of a user-interface configured for a seat allocation request, in accordance with embodiment of the present invention;

FIG. 7 provides a schematic representation of a user-interface configured for bulk release of seating allocations, in accordance with embodiments of the present invention; and

FIG. 8 provides a schematic representation of a user-interface configured for selecting work shifts for available seat allocation, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described that provide real-time access to seating information, including seat allocations/assignments and seat availability. Additionally, embodiments of the invention provide for users, such as managers or the like, to request a seat for allocation and to receive confirmation of the seat allocation/assignment in real-time. Moreover, present embodiments restrict the ability of a user to assign/allocate a previously allocated seat and prevent a user from assigning an associate more than one seat. Further by determining next-in-time available work shifts for allocation based on work shift interval and shift start time, embodiments of the present invention restrict a user from allocating a seat with overlapping time intervals.

The automated nature of the present invention eliminates seat request/allocation duplication caused by multiple managers individually requesting seats manually and, in doing so, eliminates the resulting rework associated with duplicate requests/allocations. Moreover, the real-time functionality of the present invention reduces or eliminates the need to consolidate allocation requests and updates. In addition, the real-time view of seat allocations provides for instantaneous and up-to-the-minute analysis, data and reporting, which results in more timely decisions regarding seat allocations. Additionally, by providing for real-time updates in the form of seat releases of surplus seats or the like, better utilization of seats/work stations results across the business.

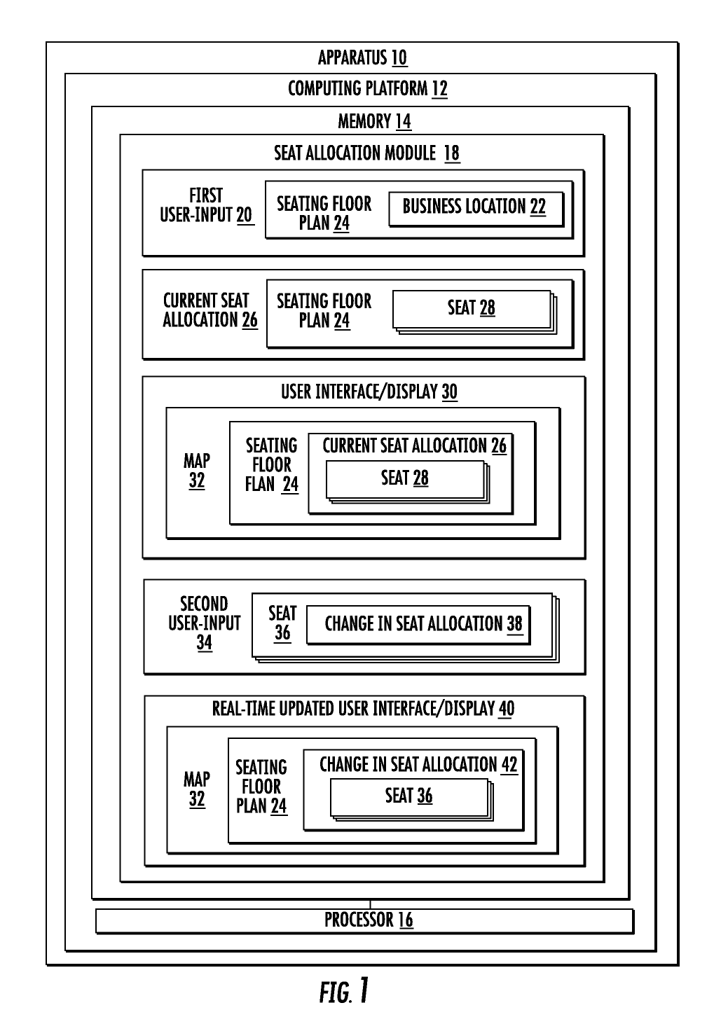

Referring to FIG. 1, a block diagram is presented of an apparatus 10 configured for providing seat allocation within a seating floor plan of a business environment, in accordance with embodiments of the present invention. The apparatus includes a computing platform 12 having a memory 14 and at least one processor 16 in communication with the memory. The memory 14 of apparatus 10 stores seat allocation module 18 that is executable by the processor 16 and configured to provide users access to seat allocation information for a selected business location, as well as request seating allocation changes, such as seating allocation requests and releases. It should be noted that seats are typically “allocated” to designated users of the module, such as managers or the like and the users can then “assign” the seats to an associate/employee that will subsequently occupy the assigned seat during the designated time period.

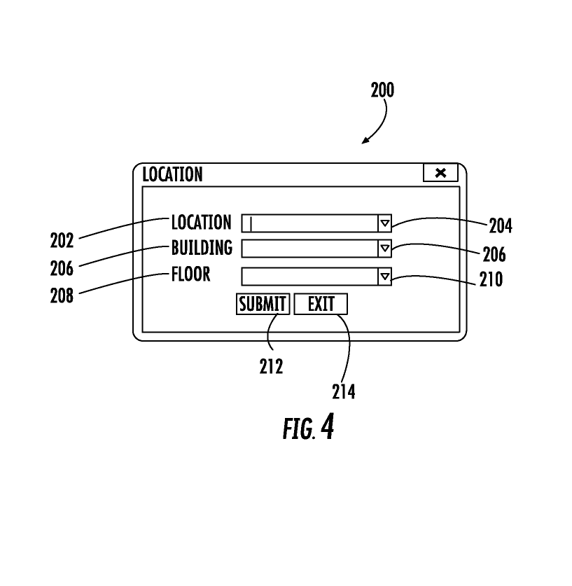

As such, seat allocation module 18 is configured receive a first user-input 20 that selects a seating floor plan 24 of a business location 22. In such embodiments of the apparatus 10, the module 18 may be configured for a user to select a business site (i.e., physical location/address or the like), a specific building at the business site and/or a floor (or module) within a specific building. In specific embodiments in which the business utilizing the seat allocation module 18 is a worldwide enterprise, the seating allocation module 18 may provide for the user to select from any global business location in which seating allocation is deemed necessary. As previously noted, seating allocation is typically required when associates/employees work in a multi work-shift around-the-clock environment, for example, call centers or the like. See FIG. 4, and the related discussion, for an illustration of a user-interface configured to receive a user selection of a seating floor plan 24 of a business location 22.

In response to receiving the first-user input 20, the seating allocation module 18 is further configured to determine the current (i.e., an up-to-the minute) seating allocation 26 for the plurality of seats 28 included the selected seating floor plan 24. In this regard the determination of the current seating allocation 26 is considered to occur in real-time or in near real-time to the user selecting a floor seat planning, so that the seating allocation information that is subsequently presented to the user accurately reflects current seating allocation. The current seating allocation 26 may be configured to indicate whether a seat has allocation availability over a next-in-time predetermined time period (e.g., the next twenty-four hours or the like) and indicate which next-in-time work shift in which the seat is available for allocation.

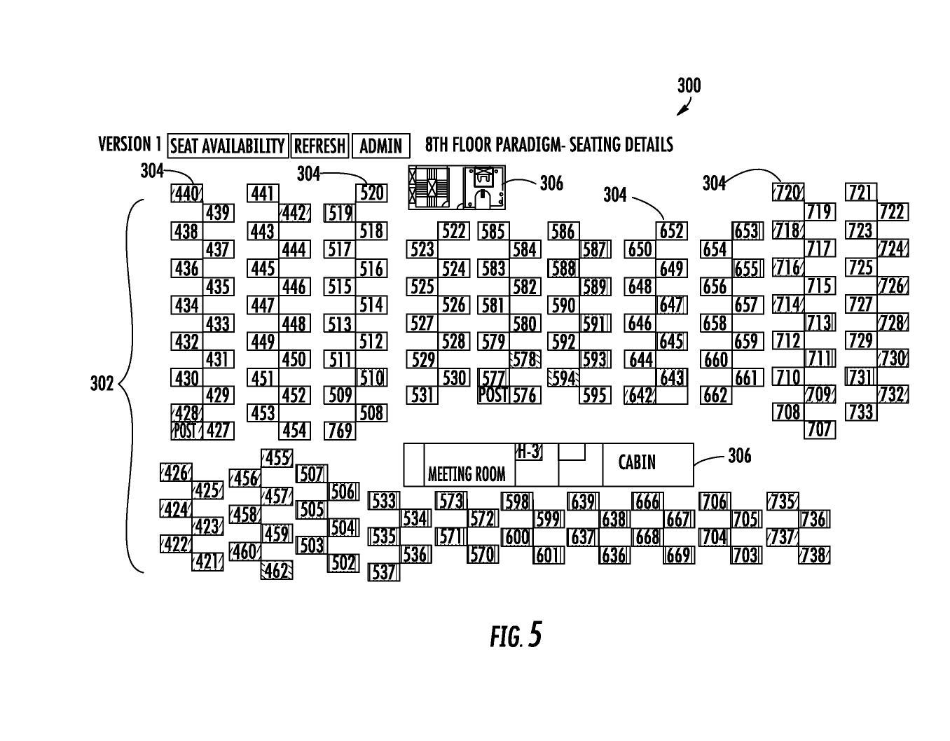

The seating allocation module 18 is further configured to provide a user-interface/display 30 of a map 32 of the seating floor plan 24 that indicates the current seat allocation 26 for the plurality of seats 28 included in the seating floor plan 24. In specific embodiments of the apparatus 10, the module 18 may be configured to indicate if a seat is available for allocation/assignment over the next-in-time work shift cycle (e.g., over the next twenty four hours, thirty-six hours or the like) and, if the seat does have availability, the next-in-time work shift that the seat becomes available for allocation. In specific embodiments of the apparatus 10, the module 18 may be configured to provide such indication by color-coding (or providing some other visual indicator) the seat icons displayed in the map 32. In specific embodiments of the apparatus, the module 18 may display a map 32 that includes work stations (not shown in FIG. 1), which include more than one seat. In such embodiments of the apparatus 10, the work stations may be configured to indicate the current seating allocation availability of seats in the work station (e.g., all seats in the work station currently unavailable for allocation over the next work shift cycle or one or more seats currently available and the next-in-time available work shift for the available seat(s)). See FIG. 5, and the related discussion, for an illustration of a display/user-interface 30 configured to provide a map 32 of the seating floor plan 24 that indicates the current seat allocation 26 for the plurality of seats 28 included in the seating floor plan 24.

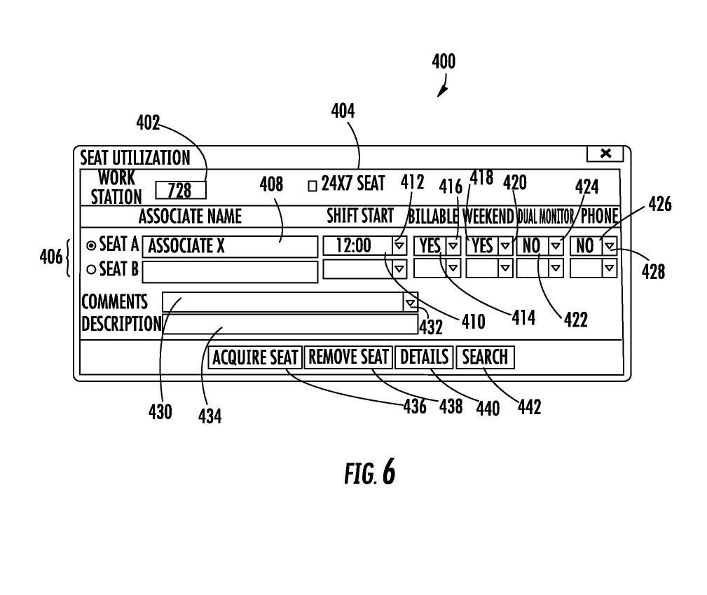

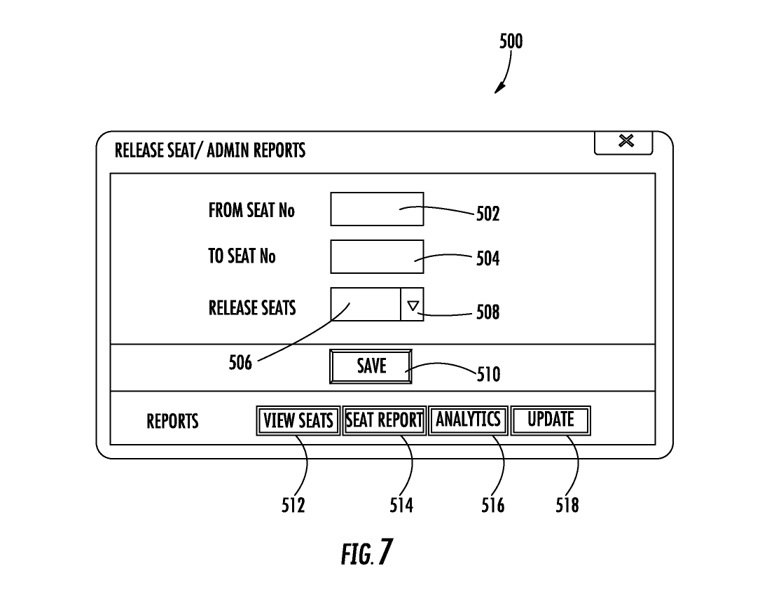

In addition, the seat allocation module 18 is configured to receive a second user-input 34 that selects one or more of the seats 36 displayed in the map 32 and requests a change in seat allocation 38 for the one or more selected seats 36. The request for change in seat allocation 36 may be a request to allocate a seat to a user or a request to release a seat previously allocated to the user. See FIGS. 6 and 7, and the related discussion, for an illustration of a display/user-interface configured to receive user-inputs that request allocation of a seat to a user (FIG. 6) and release one or more seats previously allocated to a user (FIG. 7).

In response to receiving the second user input 34, the seat allocation module 18 is further configured to confirm the change in seat allocation 36 and update, in real-time or near real-time, the user-interface/display 40 to display the map 32 of the seat floor plan 24 to indicate the change in the seat allocation 36 for the selected seats 36. In addition, the module 18 is configured to update the seat record that is stored in a centralized database to reflect the change in seat allocation. In this regard, the module 18 will prohibit a user from being allocated a seat, if the seat has already been allocated (this would be the case if another user requested allocation of the seat after the user was presented the user interface/display 30 which indicated that the seat was available or if the user failed to refresh the user/interface display 30 prior to requesting the seat). The module 18 will further prohibit assigning a seat to an associate/employee if the associate/employee already has another seat assigned to them for the specified time period/work shift.

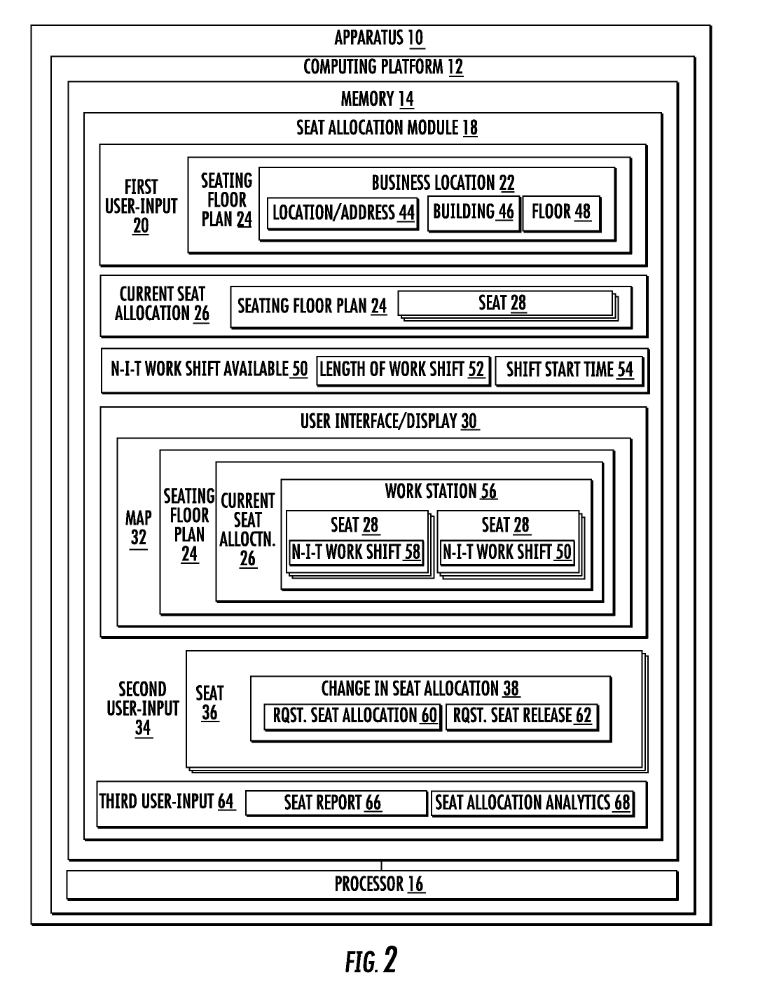

Referring to FIG. 2, more detailed block diagram of apparatus 10 is presented that highlights various alternate embodiments for providing seat allocation within a seating floor plan of a business environment, in accordance with embodiments of the present invention. The apparatus 10 which may include more than one physical device or unit is operable to receive and execute modules, routines and applications, such as seat allocation module 18 and the like.

The apparatus 10 includes a computing platform 12 that can receive and execute routines and applications. The computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, the computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 2) that interfaces with any resident programs, such as seat allocation module 18 and the like, stored in the memory 14 of apparatus 10. Processor 16 includes various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of seat allocation module 18 obviating the need for such applications and modules to be stored in the memory.

As previously noted in relation to FIG. 1, the memory 14 of apparatus 10 stores seat allocation module 18 that provides users access to seat allocation information for a selected business location, as well as request seating allocation changes, such as seating allocation requests and releases. Seat allocation module 18 is configured receive a first user-input 20 that selects a seating floor plan 24 of a business location 22. In such embodiments of the apparatus 10, the module 18 may be configured for a user to select a physical location/address 44, a specific building 46 at the business site and/or a floor 48 (or module or other designated area) within a specific building.

In response to receiving the first-user input 20, the seating allocation module 18 is further configured to determine the current (i.e., an up-to-the-minute) seating allocation 26 for the plurality of seats 28 included the selected seating floor plan 24. In this regard, the determination of the current seating allocation 26 is considered to occur in real-time or in near real-time to the user selecting a floor seat planning, so that the seating allocation information that is subsequently presented to the user accurately reflects current seating allocation. The current seating allocation 26 may be configured to indicate whether a seat has allocation availability over a next-in-time predetermined time period (e.g., the next twenty-four hours or the like) and indicate which next-in-time work shift in which the seat is available 50 for allocation. In specific embodiments of apparatus, the module 18 determines the next-in-time work shift in which the seat is available based on the length of time of a work shift 52 and the shift start time 54 of the associate/employee assigned to the seat. In this regard, if the shift start time 54 is such that the length of time of the work shift 52 will overlap with another designated work shift, the seat will be determined to not become available until the next designated work shift after the overlapped designated work shift. (E.g., the shift start time begins three hours into the morning shift and will end during the mid shift, as such, the seat will become available for allocation for the work shift following the mid shift, i.e., the evening shift).

As previously discussed in relation to FIG. 1, the seating allocation module 18 is further configured to provide a user-interface/display 30 of a map 32 of the seating floor plan 24 that indicates the current seat allocation 26 for the plurality of seats 28 included in the seating floor plan 24. In specific embodiments of the apparatus 10, the module 18 may be configured to indicate if a seat 28 is fully allocated 58 (i.e., unavailable for allocation/assignment over the next-in-time work shift cycle (e.g., over the next twenty four hours, thirty-six hours or the like) and, if the seat does have availability, the next-in-time work shift that the seat becomes available 50 for allocation. In specific embodiments of the apparatus 10, the module 18 may be configured to provide such indication by color-coding (or providing some other visual indicator) the seat icons displayed in the map 32.

In specific embodiments of the apparatus, the module 18 may display a map 32 that includes work stations 56, which include more than one seat. In such embodiments of the apparatus 10, the work stations may be configured to indicate the current seating allocation availability of seats in the work station (e.g., all seats in the work station currently unavailable for allocation over the next work shift cycle or one or more seats currently available and the next-in-time available work shift for the available seat(s)). In such embodiments, activating the icon associated with the work station may present information on the specific seats associated with the work station, including the availability of the seats for allocation and, if available, the next-in-time work shift that the seat becomes available for allocation 50 and allow the user to request seat allocation and/or release seat allocation, based on the user's desires.

In addition, the seat allocation module 18 is configured to receive a second user-input 34 that selects one or more of the seats 36 displayed in the map 32 and requests a change in seat allocation 38 for the one or more selected seats 36. The request for change in seat allocation 36 may be a request to allocate a seat to a user/manager 60 or a request to release a seat(s) previously allocated to the user 62. The request for seat allocation 60 may additionally include information relevant to the seat allocation, such as, but not limited to, the name or other identifier associated with the individual assigned to the seat and the individual's start time for the work shift. In addition, the request for release of a seat allocation may be a request in bulk that requests multiple different seats assignments to be released at the same point in time.

As shown in FIG. 1 (but omitted from FIG. 2 for the sake of clarity), in response to receiving the second user input 34, the seat allocation module 18 is further configured to confirm the change in seat allocation 36 and update, in real-time or near real-time, the user-interface/display 40 to display the map 32 of the seat floor plan 24 to indicate the change in the seat allocation 36 for the selected seats 36. In addition, the module 18 is configured to update the seat record that is stored in a centralized database to reflect the change in seat allocation.

Further, seat allocation 18 may be configured to receive a third user-input 64 that selects and initiates generation and presentation of seat report 66 and/or a seat allocation analytics 68. The seat report 66 may indicate which seats have been assigned to which individuals for an upcoming work shift and/or work shift cycle and any other information relevant to the seat allocations and/or assignments. The seat allocation analytics may provide for statistics and/or performance metrics related to seat allocation, such as utilizations statistics and other objective performance data.

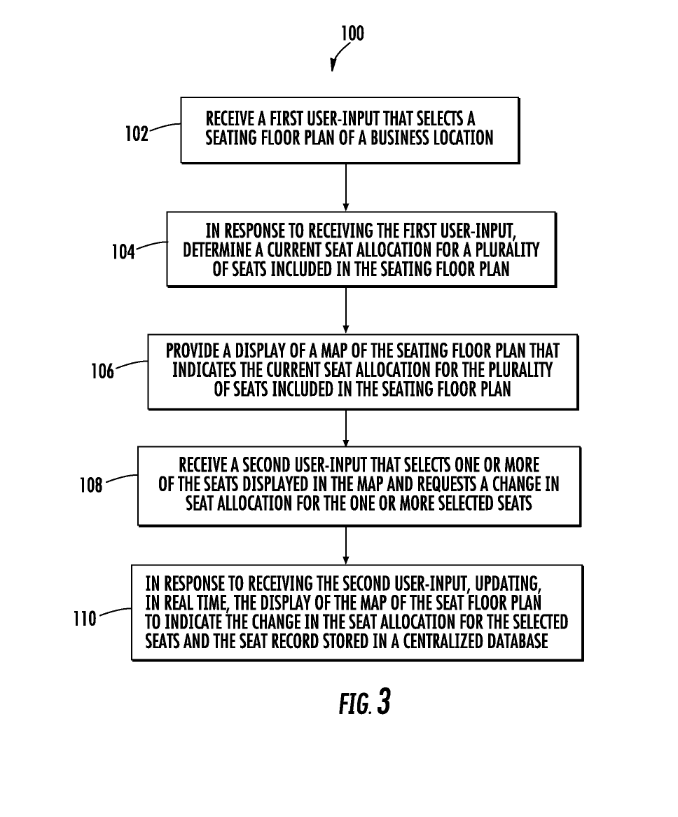

Referring to FIG. 3, a flow diagram is presented of a method 100 for providing seat allocation within a seating floor plan of a business environment, in accordance with embodiments of the present invention. At Event 102, a first user-input is received that selects a business location for a seating floor plan. The selection of the business location may include a physical location/site, a specific building within a site and/or a specific area within a building (e.g., floor, module or the like).

At Event 104, in response to receiving the first-user input, the current seat allocation is determined for the plurality of seats included in the seating floor plan. The current seat allocation determination may include determining that seat(s) are unavailable for allocation during a next-in-time work shift cycle and, if available, determining the next-in-time work shift that the seat becomes available. In such embodiments of the method, determining the next-in-time work shift in which the seat becomes available accounts for overlaps in work shifts amongst individuals assigned to a seat and, as such, is based on the length of time of the individual's work shift and the shift start time for the individual assigned to the seat.

At Event 106, a user/interface/display of a map of the seating floor plan is presented to the user. The map indicates the current seat allocation for the seats included in the floor plan. The indication may be a visual indicator assigned to a corresponding seat (or work station) icon, such as a specific color-code or the like. For example, in specific embodiments of the method, seats or work stations that are unavailable for allocation during the next-in-time work shift cycle may be indicated by one specific color-code, while seats that are available will indicate the next-in-time work shift in which they are available based on the specific color code (e.g., red indicates morning shift, blue indicates mid shift and the like).

At Event 108, a second user-input is received that selects one or more seats displayed in the map and requests a change in seat allocation for the selected seat(s). The change in seating allocation may be requesting seat allocation for an available seat or requesting release of a seat previously allocated to the user. If the user requests allocation of a seat that is no longer available or available for the time desired, the method provides for the user to be immediately notified of such, through display of a user-interface notifying the user of such. Moreover, if the user requests assignment of seat to an individual (e.g., associate/employee or the like) who already has a seat assigned to them for that specified period, the method provides for the user to be immediately notified of such, through display of a user-interface notifying the user of such.

At Event 110, in response to receiving the second user-input, the display of the map in the user/interface display is updated in real-time or near real-time to reflect the change in the seat allocation. In specific examples in which a visual indicator, such as color-coding is used to indicate seat allocation status, the update will provide for a change in the visual indicator assigned to the seat(s) that has changed seat allocation. In addition to updating the map of the seat floor plan, the seat record, which is stored in a centralized database, is updated to reflect the change in seat allocation.

In alternate embodiments of the method (not shown in FIG. 3) third user-inputs may be received that request and initiate generation and presentation of seat allocation/assignment reports and/or seat allocation analytics.

Referring to FIG. 4, an exemplary user-interface 200 of a seat allocation module configured for receiving first user-inputs that select a business location for seating floor plan presentation, in accordance with embodiments of the present invention. The user-interface includes location entry field 202 and corresponding drop down menu 204, building entry field 206 and corresponding drop down menu 206 and floor entry field 208 and corresponding drop down menu 210. The user will select a location, such as physical location/address from a listing of locations provided by activating drop down menu 204. The selection of a location by the user, from the drop down menu 204, populates the location entry field 202 and provides for a corresponding listing of buildings at the selected location to be displayed once the building drop down menu 210 is activated. The selection of a building by the user, from the drop down menu 206, populates the building entry field 206 and provides for a corresponding listing of floors within the building having associated seating plans to be displayed once the drop down menu 210 is activated. The selection of a floor by the user, from the drop down menu 210, populates the floor entry field 210. The user-interface 200 additionally includes submit key 212 and exit key 214. Submit key 212 is configured to be activated by the user once the appropriate business location entries have been inputted in fields 202, 206 and/or 208. Once the submit key 212 has been activated the current seat allocations for the seating floor plan of the selected business location are determined. Exit key 214 is configured to be activated by the user to return to a seat allocation module home page or exit the seat allocation module altogether.

Referring to FIG. 5 an exemplary user-interface 300 is shown that includes a map 302 of work stations 304 located at a business location, each work station 304 indicating the seat allocation status of one or more of the seats included in the work station, in accordance with embodiments of the present invention. The display of user-interface 300 is in response to a user activating the submit key 212 of FIG. 4. Each work station 304 indicates the number assigned to the work station and the current seat allocation status. As shown, the current seat allocation status is visually indicated by color-coding (shown in FIG. 5 by way of shading). Work stations in which no seats at the station are available for allocation during the next-in-time work shift cycle may be indicated one color/shading, while work stations having a work shift available for allocation during the next-in-time work shift cycle will be indicated by other colors/shading, such that each color indicates a different work shift/zone (e.g., morning shift, mid shift, evening shift, night shift and the like) in which at least one seat included in the work station 304 becomes available for allocation. The map 302 may additionally include other items 306 in the floor plan of the business location, which may or may not include work stations 304 that have seats to be allocated. A user, such as a manger or the like, may activate a work station 304 icon to request allocation of a seat(s) within a work station. Activation of a work station 304 icon to request allocation of seats results in presentation of a user-interface, such as the one shown and described in relation to FIG. 6. It should be noted that if a work station indicates that no seats at the station are currently available for allocation the associated work station 304 may be configured such that activation is not possible or, if the seats have been allocated to the user, activation is limited to displaying a user-interface (see FIG. 7) configured for releasing the seat allocation.

Referring to FIG. 6 an exemplary user-interface 400 is shown that allows a user to request a seat for allocation and assign an associate/employee to the seat, in accordance with embodiments of the present invention. As previously noted user-interface 400 may be accessed by activating a work station 306 icon shown in FIG. 5 that indicates that a seat within the work station is available for seat allocation. The user-interface 400 includes work station entry field 402 that displays the number/identifier of the work station selected from the map 302 (FIG. 5) or allows the user to enter another number/identifier of another work station, which results in seat assignment request entry fields for seats included in the other work station. In addition, user-interface 400 includes radio button 404 which when activated by the user or displayed as being activated indicates that the seat is allocated or requested to be allocated to the user or another user on a round-the-clock basis (i.e., 24/7—Twenty-four hours a day and seven days a week).

User-interface 400 additionally includes radio buttons 406 which when activated by the user indicate which specific seat within the work station that the user is requesting allocation. Additionally, the user-interface 400 includes fields for entering information about the seat allocation, including an associate name entry filed 408 for entering the name of the associate/employee that is assigned to the seat; a shift start time entry field 410 and corresponding drop down menu 412 for entering/selecting a shift start time for the associate assigned to the seat. The user-interface 400 may additionally be configured for entering other information about the seat allocation. In the illustrated example of FIG. 6, such other information includes, but is not necessarily limited to, a billable entry field 414 and corresponding drop down menu 416 for entering/selecting an indication of whether the seat utilization is for billable purposes; a weekend entry field 418 and corresponding drop down menu 420 for entering/selecting an indication of whether the seat allocation occurs over a weekend time period; a dual monitor entry field 422 and corresponding drop down menu 424 that indicates whether the seat includes a dual monitor display; and a telephone entry field 426 and corresponding drop down menu 428 that indicates whether the seat includes a telephone. In alternate embodiments of the invention user-interface 400 may be configured to enter/capture other additional seat allocation in lieu of or addition to the other information shown in FIG. 6. In addition, user-interface 400 is configured to provide comments entry field 430 and corresponding drop down menu 432 for entering/selecting any comments that need to be recorded in the seat allocation record, and description entry field 434 for entering any free form text entry that needs to be recorded in the seat allocation record.

Moreover, user-interface 400 includes an assign seat key 436 which upon activation by the user allocates the seat to the user and assigns the set to the identified associate. It should be noted that if the seat is no longer available when the user activates the assign seat key 436 a pop-up window is displayed notifying the user of such and/or if the associate has already been assigned to a seat for the designated work shift a pop-up window is displayed notifying the user of such. Additionally, remove/release seat key 438 is configured to be activated by a user to remove/release a seat previously allocated to the user and/or assigned to an associate. It should be noted that the module is configured such that only the user that has been previously been allocated the seats or the reporting manger of the associate to whom the seat is assigned (which may be the same as the “user”) can subsequently request release/removal of the seat allocation and/or seat assignment. In specific embodiments of the invention, activation of the remove seat key 438 results in display of the user-interface shown and displayed in FIG. 7, which provides for release of one or more seats. Details key 440 is configured to be activated by a user to provide access to the seat record or other details associated with the seat utilization/request and search key 442 is configured to be activated by a user to launch a search engine that is configured to allow the user to input search criteria to find specific seat allocations/assignments or the like.

Referring to FIG. 7 an exemplary user-interface 500 is shown that allows users to release previous seat allocations/assignments and specifically release previous seat allocations/assignments in bulk (i.e., more than one seat released in unison), in accordance with embodiments of the present invention. It should be noted that the module is configured such that only the user that has been previously been allocated the seats or the reporting manger of the associate to whom the seat is assigned (which may be the same as the “user”) is able to request release of the seats from allocation. The user-interface 500 includes seat number/identifier entry fields 502 and 504 that allow the user to enter a number/identifier range of previously allocated/assigned seats, which the user desires to release from allocation and a release seat entry field 506 and corresponding drop down menu 508 which is configured to provide a listing of the seats within the identified seat number range that are allocated to the user and allow the user to choose the seats within the designated seat number/identifier range, which the user desires to release. Additionally, user-interface 500 includes save key 510 which is configured to be activated by the user to implement the request seat(s) release (i.e., update the maps indicating seat allocations and the seat record(s) for the released seat(s)).

Additionally, user-interface 500 includes view seats key 512 that is configured to be activated by the user to provide display of the seat map associated with the requested sets to be released; seat report key 514 that is configured to be activated by the user to generate a seat report, which shows seat allocation/assignment details; seat analytics key 516 that is configured to be activated by the user to generate seat allocation analytics; and update key 518 that is configured to be activated by the user to update the seat records in light of the seat release requests.

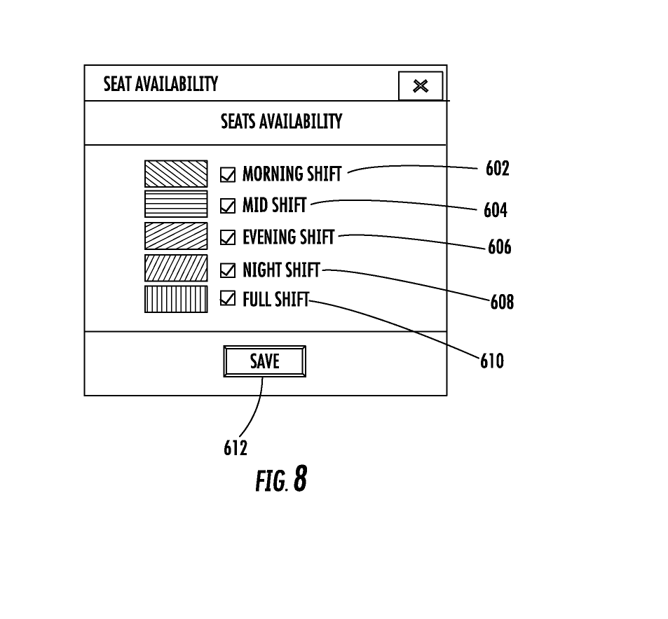

Referring to FIG. 8, an exemplary user-interface 600 is shown that is configured to allow the user to select specific work shifts/zones for displaying availability in the user-interface 300 of FIG. 5, in accordance with embodiments of the present invention. It should be noted that user-interface 600 may be accessed by the user in response to activating a seat availability key 308 included within user-interface 300. User-interface 600 includes morning shift radio button 602, mid shift radio button 604, evening shift radio button 606, night shift radio button 608 and all day (i.e., all work shifts) radio button 610; such that the user may activate one or more of the radio buttons and, upon activation of the save key 612, is presented display of a user-interface 300 that shows the current seat availability for the selected work shifts/zones. If two or more work shift/zones are selected or if all day is selected, user-interface 300 will display an indication of the next-in-time available work shift from all work shifts/zones (i.e., all day selected) or the selected work shifts/zones.

Thus, systems, apparatus, methods, and computer program products described above provide for real-time access to seating/work station information, including seat allocations/assignments and seat availability. Users are provided the ability to request a seat for allocation and to receive confirmation of the seat allocation/assignment in real-time. The automated nature of the present invention eliminates seat request/allocation duplication caused by multiple managers individually requesting seats manually and, in doing so, eliminates the resulting rework associated with duplicate requests/allocations. Moreover, the real-time functionality of the present invention reduces or eliminates the need to consolidate allocation requests and updates. In addition, the real-time view of seat allocations provides for instantaneous and up-to-the-minute analysis, data and reporting, which results in more timely decisions regarding seat allocations.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for providing seat allocation within a seating floor plan of a business environment, the system comprising:
a computing platform having a memory and at least one processor in communication with the memory;
a seat allocation module stored in the memory, executable by the processor and configured to (1) receive a first user-input that selects a seating floor plan of a business location, (2) in response to receiving the first user-input, determine a current seat allocation for a plurality of seats included in the seating floor plan, (3) provide a display of a map of the seating floor plan that indicates the current seat allocation for the plurality of seats included in the seating floor plan, (4) receive a second user-input that selects one or more of the seats displayed in the map of the seating floor plan and requests a change in seat allocation for the one or more selected seats, and (5) in response to receiving the second user-input, updating, in real-time, the display of the map of the seat floor plan to indicate the change in the seat allocation for the one or more selected seats.

2. The apparatus of claim 1, wherein the seat allocation module is further configured to, in response to receiving the second user-input, store, in a centralized database, the change in the seat allocation in a corresponding seat assignment record.

3. The apparatus of claim 1, wherein the seat allocation module is further configured to provide the display of the map of the seating floor plan that indicates for each seat displayed in the map one of (1) allocated for a next-in-time work shift cycle, or (2) a next-in-time work shift that the seat is available for allocation.

4. The apparatus of claim 3, wherein the seat allocation module is further configured to determine the next-in-time work shift that the seat is available for allocation based on length of time of a work shift period and a shift start time associated with a seat assignment.

5. The apparatus of claim 1, wherein the seat allocation module is further configured to provide the display of the map of the seating floor plan that indicates the current seat allocation for a plurality of work stations included in the seating floor plan, wherein each work stations includes one or more seats.

6. The apparatus of claim 1, wherein the seat allocation module is further configured to receive the second user-input that selects one of the seats in the map of the seating floor plan and requests seat assignment for the selected seat, wherein seat assignment includes an associate name that is being assigned to the seat and shift start time.

7. The apparatus of claim 1, wherein the seat allocation module is further configured to receive the second user-input that selects a plurality of the seats and requests release of seat assignment for the selected plurality of seats.

8. The apparatus of claim 1, wherein the seat allocation module is further configured receive the first user-input that selects the seating floor plan of a business location, wherein the seating floor plan is specific to a least one of a physical location, a building at the physical location and a floor within the building.

9. The apparatus of claim 1, wherein the seat allocation module is further configured to receive a third user-input that selects a seat report for the seating floor plan and, in response to receiving the third user-input, generate, in real-time, the seat report and provide a seat report display to the user that includes details of current seat allocation.

10. The apparatus of claim 1, wherein the seat allocation module is further configured to receive a third user-input that selects a seat allocation analytics and, in response to receiving the third user-input, generate, in real-time, seat allocation analytics that includes statistics related to seat allocation.

11. A method for assigning seats at workplace seating location, the method comprising:
receiving, by a computing device processor, a first user-input that selects a seating floor plan of a business location;
in response to receiving the first user-input, determining, by a computing device processor, a current seat allocation for a plurality of seats included in the seating floor plan;
providing, by a computing device processor, a display of a map of the seating floor plan that indicates the current seat allocation for the plurality of seats included in the seating floor plan;
receiving, by a computing device processor, a second user-input that selects one or more of the seats displayed in the map of the seating floor plan and requests a change in seat allocation for the one or more selected seats; and
in response to receiving the second user-input, updating, in real-time, the display of the map of the seat floor plan to indicate the change in the seat allocation for the one or more selected seats.

12. The method of claim 11, further comprising, in response to receiving the second user-input, storing, in a centralized database, the change in the seat allocation in a corresponding seat assignment record.

13. The method of claim 11, wherein providing the display of the map further comprises providing, by the computing device processor, the display of the map of the seating floor plan that indicates for each seat displayed in the map one of (1) allocated for a next-in-time work shift cycle, or (2) a next-in-time work shift that the seat is available for allocation.

14. The method of claim 13, further comprising, determining, by a computing device processor, the next-in-time work shift that the seat is available for allocation based on length of time of a work shift period and a shift start time associated with a seat assignment.

15. The method of claim 11, wherein providing display of the map further comprises providing, by a computing device processor, the display of the map of the seating floor plan that indicates the current seat allocation for a plurality of work stations included in the seating floor plan, wherein each work stations includes one or more seats.

16. The method of claim 11, wherein receiving the second user-inputs further comprises receiving, by the computing device processor, the second user-input that selects one of the seats in the map of the seating floor plan and requests seat assignment for the selected seat, wherein seat assignment includes an associate name that is being assigned to the seat and shift start time.

17. The method of claim 11, wherein receiving the second user-inputs further comprises receiving, by the computing device processor, the second user-input that selects a plurality of the seats and requests release of seat assignment for the selected plurality of seats.

18. The method of claim 11, further comprises receiving, by a computing device processor, a third user-input that selects one of (1) a seat report for the seating floor plan or (2) seat allocation analytics and, in response to receiving the third user-input, generate, in real-time, (1) the seat report, or (2) seat allocation analytics and provides (1) a seat report display to the user that includes details of current seat allocation, or (2) seat allocation analytics that includes statistics related to seat allocation.

19. The method of claim 11, further comprising:
receiving, by a computing device, third user-input that select a work shift for indicating seat availability on the map; and
in response to receiving the third user-input, providing, by a computing device, display of a work shift-specific map that indicates which seats are available for assignment during the selected work shift.

20. A computer program product comprising:
a non-transitory computer-readable medium comprising:
a first set of codes for causing a computer to receive a first user-input that selects a seating floor plan of a business location;
a second set of codes for causing a computer to, in response to receiving the first user-input, determine a current seat allocation for a plurality of seats included in the seating floor plan;
a third set of codes for causing a computer to provide a display of a map of the seating floor plan that indicates the current seat allocation for the plurality of seats included in the seating floor plan,
a fourth set of codes for causing a computer to receive a second user-input that selects one or more of the seats displayed in the map of the seating floor plan and requests a change in seat allocation for the one or more selected seats; and
a fifth set of codes for causing a computer to, in response to receiving the second user-input, update, in real-time, the display of the map of the seat floor plan to indicate the change in the seat allocation for the one or more selected seats.
